(19) United States
(12) Patent Application Publication
(10) Pub. No.: US 2020/0218293 A1
(43) Pub. Date: Jul. 9, 2020

(54) HOT TEMPERATURE RESTRICTED VALVE

(71) Applicant: GM GLOBAL TECHNOLOGY OPERATIONS LLC, Detroit, MI (US)

(72) Inventors: Daniel I. Culler, Oxford, MI (US); Sean M. McGowan, Northville, MI (US); Mark R. Claywell, Birmingham, MI (US)

(21) Appl. No.: 16/243,296

(22) Filed: Jan. 9, 2019

(51) Int. Cl. G05D 23/13; F01P 7/16; F01M 5/00; F01P 3/00

(52) U.S. Cl. CPC G05D 23/132; F01P 7/16; F01P 2007/146; F01P 3/00; F01M 5/002

(57) ABSTRACT

A temperature responsive valve includes a housing and a cylindrical structure disposed within the housing. The housing defines an inlet passageway and an outlet passageway wherein the cylinder body of the cylindrical structure is disposed between the inlet passageway and the outlet passageway. The cylindrical structure includes a first layer so that the cylindrical structure is configured to expand from a decreased diameter to an increased diameter when the first layer of the cylindrical structure is exposed to an increased pre-determined temperature range causing the cylindrical structure restricts the inlet passageway and the outlet passageway at such increased pre-determined temperature range.

### TECHNICAL FIELD

The present disclosure generally relates to a bypass valve which opens and closes depending upon temperature.

### BACKGROUND

Engine, transmission and power steering systems use oil with a viscosity that varies greatly with changes in temperature. Oil coolers remove the heat from the oil. The high performance cooler core has small hydraulic diameters that can also be described as having small passages. These passages may also have “turbulators” or “fins” to better transfer the heat. Cold weather causes oil flow through these small passages to be greatly restricted because the oil viscosity can increase greatly at lower temperatures.

In cold weather, the oil systems must still be capable of removing the excess heat. A portion or portions of the system is often continuously releasing heat into the oil in areas that can be described as “hot spots.” Such hot spots are found at areas such as the engine pistons, transmission torque converters, hydraulic fan motors, power steering hydraulic motor, bearing and gear areas. In cold weather, oil still needs to flow through the “hot spot” areas so that heat can be dissipated into and from flowing oil. This also helps prevent oil from overheating or burning.

The high performance coolers use long ports with small cross sections to create turbulent flow so that the oil flow becomes more restricted as the oil cools. The ability of the fluid to flow in small hydraulic diameters is dependent on the increasing temperature. As the temperature decreases, the oil becomes very thick and requires much higher differential pressure to flow the oil through the core or in severe cold cases, the flow may virtually cease.

The cooling circuit must allow the oil to flow to return to the power system from which it came to act as both coolant and lubricant. Some oil cooler systems have a permanently open bypass orifice, between the upstream and downstream portion of the core, requiring additional core compensation to cool the oil that is not bypassed to compensate for bypassing hot oil. The low viscosity hot oil passing through the bypass orifice and past the oil cooler is substantial. The core size must be increased to compensate for the extra heat in the bypass oil.

Another known system uses a thermal actuator to open a first bypass port to act against a valve seat with a secondary spring portion to apply a second valve seat such as is described in U.S. Pat. No. 6,499,666. This requires additional components such as a thermal piston, two springs and two independent valve seat components to accomplish the bypass function and drives the cost of such an addition to higher piece cost levels. Increasing the number of components to perform the actuation increases the variability of opening and closing actuation at specified temperatures and pressures. A high pressure relief valve may be required and may require additional components such as in the power steering cooler circuit an additional ball and spring may be required. The bypass circuit has a piston valve with a thermal expansion wax like material behind the piston valve. The “wax like” material is behind a piston or diaphragm that provides adequate force and travel to move the valve, but the assembly is relatively expensive. The assembly usually has a secondary high-pressure “popper” valve and a spring to provide high-pressure relief around the closed thermal valve portion. The dual systems with its multiple components have these components as added costs.

The radiator “in-tank” tank oil cooler is limited in size due to packaging space. Therefore, it is generally limited in heat transfer capability for the extremely hot conditions. The high efficiency of the external oil cooler in colder ambient temperatures can limit flow of the oil because the oil flow to because of extremely high viscosity of oil trying to flow through the core small tube passages in the cooler core. The restricted flow limits the lubrication and cooling of the downstream components.

The pressure difference across the aforementioned systems causes the fluid to flow from the high potential to the low potential portion of the system. The metric version is usually in kilopascals (kPa) or megapascals (MPa). In the case of the power steering, transmission and engine coolers, they are “areas of resistance to flow”. Oil coolers receive upstream oil from the portion of the systems which do most of the work and lose part of their efficiency as heat energy into the oil. Oil through the cooler circuit meets with some resistance as it flows through the cooler lines and increases greatly as it flow through the high performance cooler passages. In state- of-the-art high performance coolers, the passages have small hydraulic diameters with the size of the passages decreased to improve cooling performance. The smaller passages are sensitive to viscosity change. This condition can be considered as a variable resistance relative to temperature change because the oil viscosity changes so greatly relative to temperature. The consistency of the oils changes from a “honey like” thickness at extremely cold condition and a “watery like” thickness at high temperatures.

The oil cooler has a high resistance to flow when the oil is extremely cold similar to a flow passage with a very small orifice. The oil cooler has a low resistance to flow when the oil is extremely hot similar to a flow passage with a very large orifice. The system oil pump tries to push the oil flow until it reaches the maximum allowable system oil pressure. The differential pressure from upstream to downstream of the core with cold oil is extremely high. In large transport trucks and even some large Sport Utility Vehicles (SUVs) the system pressure limits can be higher. Some oil cooler circuits have a bypass circuit to flow around the cooler. This bypass is used to either reduce pressure across the circuit or to provide flow back to the heat emitting portion to provide an early warm up of the oil in the system.

The need exists for a simplified valve system to minimize the effect of high pressure via a temperature sensitive bypass valve which doses once the system temperatures reach a pre-determined higher temperature.

### SUMMARY

The present disclosure provides a temperature responsive valve which may be implemented in a variety of different components, including but not limited to an oil cooler. The temperature responsive valve includes a housing and a cylindrical structure disposed within the housing. The housing defines an inlet passageway and an outlet passageway wherein the elongated housing of the cylindrical structure is disposed between the inlet passageway and the outlet passageway. The cylindrical structure includes a first layer so that the cylindrical structure is configured to expand from a decreased diameter to an increased diameter when the first layer of the cylindrical structure is exposed to an increased pre-determined temperature range causing the cylindrical structure restricts the inlet passageway and the outlet passageway at such increased pre-determined temperature range. It is understood that the first layer may be rolled to form the cylindrical structure. Moreover, the first layer may be formed from any one of a variety of materials including but not limited to a shape memory alloy.

The cylindrical structure of the aforementioned temperature responsive valve may optionally include a second layer affixed to the first layer wherein the second layer spans across a first side of the first layer. Regardless of whether the cylindrical structure is formed by a single layer first layer or by two layers (formed by the first layer and the second layer). The layer(s) are rolled to form the cylindrical structure. When two layers are implemented, each of the first layer and the second layer maybe formed from wherein the first layer and the second layer have different thermal coefficients of expansion. However, when only the first layer is implemented, then the first layer may be formed by a shape memory alloy.

The housing of the temperature responsive valve may further define a bore having an interior housing diameter wherein the bore is fluidly coupled to both the inlet passageway and the outlet passageway of the housing. The bore is configured to retain the cylindrical structure such that the cylindrical structure is disposed within the bore regardless of whether or not the cylindrical structure is expanded to the increased diameter or the cylindrical structure has the decreased diameter. Accordingly, the interior housing diameter is greater than each of the decreased diameter and the increased diameter of the cylindrical structure. The cylindrical structure is configured to freely move within the bore when the housing and the cylindrical structure are exposed to a cooler temperature which is less than the pre-determined temperature. However, when the housing and the cylindrical structure are exposed to an increased temperature which is greater than the pre-determined temperature, the cylindrical structure fully expands within the bore thereby blocking the inlet passageway and the outlet passageway.

The first layer of the temperature responsive valve may be rolled to form the cylindrical structure. However, where a second layer is optionally affixed across the first layer, the second layer is rolled together with the first layer to form the cylindrical structure.

In order to assemble the temperature responsive valve, the housing is formed by a first portion or half which is mechanically affixed to a second portion or half after the cylindrical structure is disposed within a portion of the first half of the housing. At least one of the first and second portions of the housing may define a bore which is configured to retain the cylindrical structure within the housing. Therefore, it is understood that the cylindrical structure may be disposed between the first portion and the second portion. Thus, the first portion and the second portion of the housing may define a bore configured to retain the cylindrical structure between the inlet passageway and the outlet passageway.

The temperature responsive valve may be implemented on any one of a variety of components, such as but not limited to an oil cooler.

The present disclosure and its particular features and advantages will become more apparent from the following detailed description considered with reference to the accompanying drawings.

### BRIEF DESCRIPTION OF THE DRAWINGS

These and other features and advantages of the present disclosure will be apparent from the following detailed description, best mode, claims, and accompanying drawings in which:

FIG. 1 illustrates an example, non-limiting oil cooler having a temperature responsive valve.

FIG. 2A is an enlarged view of the example, non-limiting temperature responsive valve shown in FIG. 1 wherein the cylindrical structure is shown having a decreased diameter (contracted state).

FIG. 2B is an enlarged view of the example, non-limiting temperature responsive valve shown in FIG. 1 wherein the cylindrical structure is shown having an increased diameter (expanded state).

FIG. 3A is an enlarged view of a second example, non-limiting temperature responsive valve wherein the cylindrical structure is shown having a decreased diameter (contracted state).

FIG. 3B is an enlarged view of the example, non-limiting temperature responsive valve shown in FIG. 3A wherein the cylindrical structure is shown having an increased diameter (expanded state).

FIG. 4 is an enlarged view of a third example, non-limiting temperature responsive valve wherein the cylindrical structure is shown having a decreased diameter (contracted state).

FIG. 5 is an enlarged view of the example, non-limiting temperature responsive valve shown in FIG. 4 wherein the cylindrical structure is shown having an increased diameter (expanded state).

Like reference numerals refer to like parts throughout the description of several views of the drawings.

### DETAILED DESCRIPTION

Reference will now be made in detail to presently preferred compositions, embodiments and methods of the present disclosure, which constitute the best modes of practicing the present disclosure presently known to the inventors. The figures are not necessarily to scale. However, it is to be understood that the disclosed embodiments are merely exemplary of the present disclosure that may be embodied in various and alternative forms. Therefore, specific details disclosed herein are not to be interpreted as limiting, but merely as a representative basis for any aspect of the present disclosure and/or as a representative basis for teaching one skilled in the art to variously employ the present disclosure.

Except in the examples, or where otherwise expressly indicated, all numerical quantities in this description indicating amounts of material or conditions of reaction and/or use are to be understood as modified by the word “about” in describing the broadest scope of the present disclosure. Practice within the numerical limits stated is generally preferred. Also, unless expressly stated to the contrary: percent, “parts of,” and ratio values are by weight; the description of a group or class of materials as suitable or preferred for a given purpose in connection with the present disclosure implies that mixtures of any two or more of the members of the group or class are equally suitable or preferred; the first definition of an acronym or other abbreviation applies to all subsequent uses herein of the same abbreviation and applies to normal grammatical variations of the initially defined abbreviation; and, unless expressly stated to the contrary, measurement of a property is determined by the same technique as previously or later referenced for the same property.

It is also to be understood that this present disclosure is not limited to the specific embodiments and methods described below, as specific components and/or conditions may, of course, vary. Furthermore, the terminology used herein is used only for the purpose of describing particular embodiments of the present disclosure and is not intended to be limiting in any way.

It must also be noted that, as used in the specification and the appended claims, the singular form “a,” “an,” and “the” comprise plural referents unless the context clearly indicates otherwise. For example, reference to a component in the singular is intended to comprise a plurality of components.

The term “comprising” is synonymous with “including,” “having,” “containing,” or “characterized by.” These terms are inclusive and open-ended and do not exclude additional, un-recited elements or method steps.

The phrase “consisting of” excludes any element, step, or ingredient not specified in the claim. The phrase “consisting essentially of” limits the scope of a claim to the specified materials or steps, plus those that do not materially affect the basic and novel characteristic(s) of the claimed subject matter.

The terms “comprising”, “consisting of”, and “consisting essentially of” can be alternatively used. Where one of these three terms is used, the presently disclosed and claimed subject matter can include the use of either of the other two terms.

Throughout this application, where publications are referenced, the disclosures of these publications in their entireties are hereby incorporated by reference into this application to more fully describe the state of the art to which this present disclosure pertains.

The following detailed description is merely exemplary in nature and is not intended to limit the present disclosure or the application and uses of the present disclosure. Furthermore, there is no intention to be bound by any theory presented in the preceding background or the following detailed description.

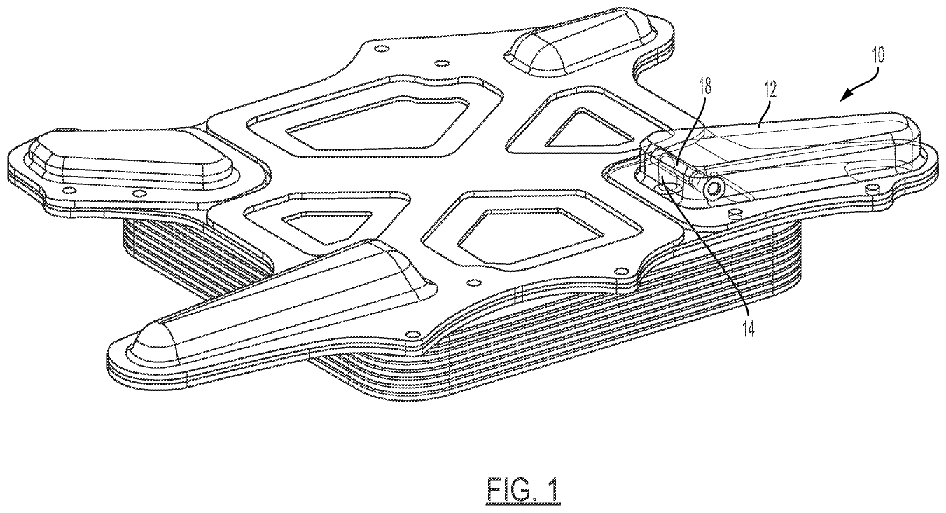

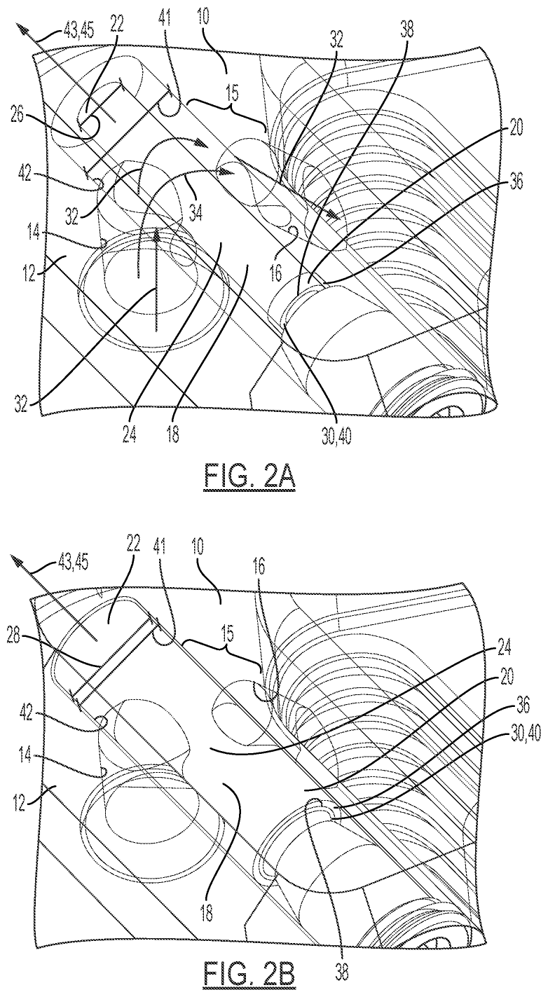

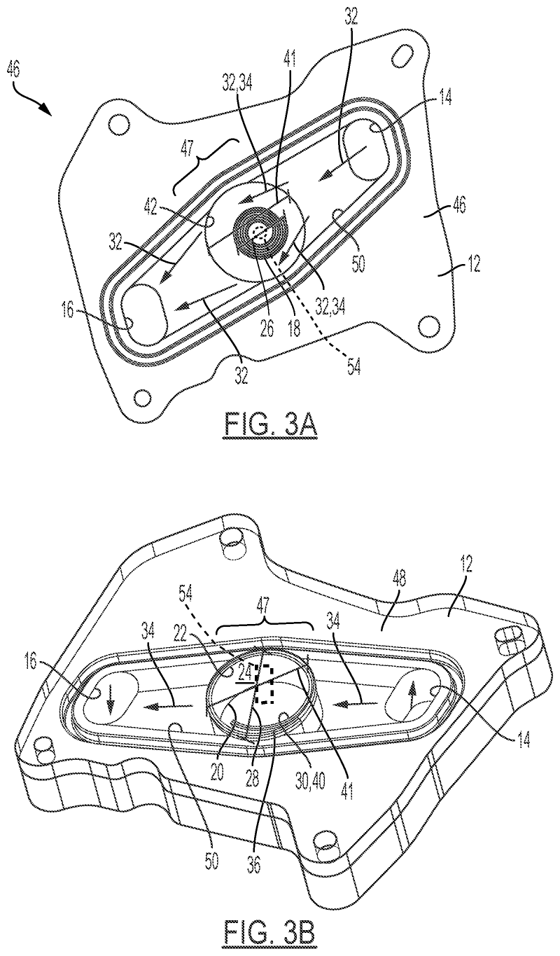

Referring now to FIG. 1, the present disclosure provides a temperature responsive valve 10 which may be implemented in a variety of different components, including but not limited to an oil cooler which is shown as a non-limiting example only. With reference to different non-limiting example embodiments shown in FIGS. 2A-5, the temperature responsive valve 10 includes a housing 12 and a cylindrical structure 18 disposed within the housing 12. The housing 12 defines an inlet passageway 14 and an outlet passageway 16 wherein the (optionally elongate) cylinder body 24 of the cylindrical structure 18 is disposed between the inlet passageway 14 and the outlet passageway 16. The cylinder structure 18 defines a proximate end 20, a distal end 22, and a cylinder body 24 therebetween. As shown in FIGS. 2A-2B and 3A-B, the axis 45 of the cylindrical structure 18 is substantially parallel to the axis 43 of the bore 42 defined within the housing 12. However, as shown in FIGS. 3A-3B, the axis 45 of the cylindrical structure 18 is substantially perpendicular to the fluid pathway 34 within the cavity 50 defined in the housing 12 shown in FIG. 3A-3B.

The example of FIGS. 2A-2B illustrates an embodiment wherein the inlet passageway 14 and the outlet passageway 16 of the housing 12 are optionally defined proximate to a central region 15 of the bore 42. In this non-limiting example, cylindrical structure 18 includes a first layer 30 so that the cylindrical structure 18 is configured to expand from a decreased diameter 26 to an increased diameter 28 when the first layer 30 of the cylindrical structure 18 is exposed to a fluid 32 at an increased pre-determined temperature causing the cylindrical structure 18 restricts the fluid pathway 34 between the inlet passageway 14 and the outlet passageway 16 at such increased pre-determined temperature. An example non-limiting increased pre-determined temperature may, but not necessarily, be 40 degrees Celsius. It is understood that the first layer 30 may be rolled to form the cylindrical structure 18 as shown.

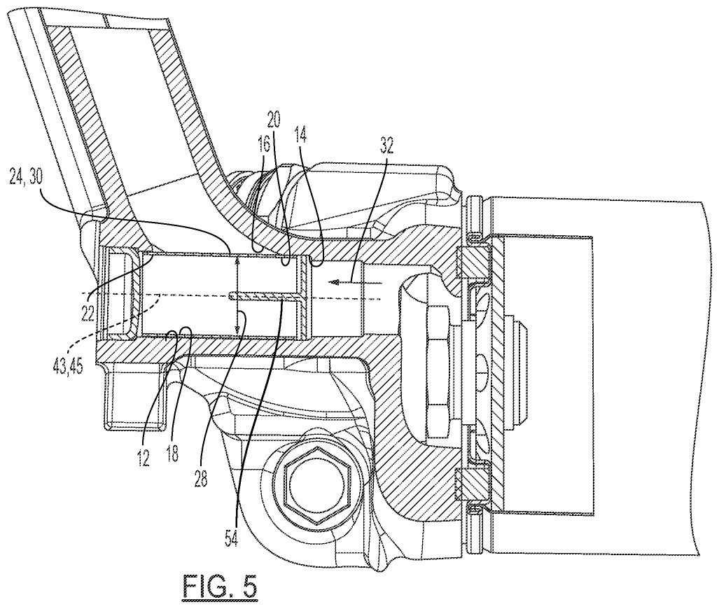

With respect to all embodiments of the present disclosure, the cylindrical structure 18 of the temperature responsive valve 10 may optionally include a second layer 36 affixed to the first layer 30 wherein the second layer 36 spans across a first side 38 of the first layer 30—and is rolled together with the first layer 30 to form a cylindrical structure 18. In forming the cylindrical structure 18 of any embodiment of the present disclosure, the first layer 30 may, but not necessarily, be rolled in multiple revolutions as shown in example FIGS. 3A-3B. The second layer 36 may have a temperature coefficient which differs from the temperature coefficient of the first layer 30. However, similar to the first layer 30, when the second layer 36 of the cylindrical structure 18 is exposed to a fluid 32 having an increased pre-determined temperature range causing the first and second layers 30, 36 to expand (by either slightly unrolling as shown in FIGS. 2A-3B or by expanding as shown in FIG. 5) such that cylindrical structure 18 restricts the fluid pathway 34 between the inlet passageway 14 and the outlet passageway 16 at such increased pre-determined temperature range. Moreover, each of the first layer 30 and/or the second layer may be formed from any one of a variety of materials including but not limited to a shape memory alloy 40.

However, with reference to the additional, non-limiting example in FIGS. 3A-3B, an example embodiment is shown wherein the inlet passageway 14 is optionally defined at a first end of the cavity 50 of the housing 12 and the outlet passageway 16 of the housing 12 is optionally defined at a second end of the cavity 50 such that the cylindrical structure 18 restricts the fluid pathway 34 which is defined between the inlet passageway 14 and the outlet passageway 16. Similar to the non-limiting example of FIGS. 2A-2B, the cylindrical structure 18 in FIGS. 3A, 3B includes a first layer 30 so that the cylindrical structure 18 is configured to expand from a decreased diameter 26 to an increased diameter 28 when the first layer 30 of the cylindrical structure 18 is exposed to a fluid 32 having an increased pre-determined temperature range causing the cylindrical structure 18 restricts fluid pathway 34 between the inlet passageway 14 and the outlet passageway 16 at such increased pre-determined temperature range. It is understood that the first layer 30 may be rolled to form the cylindrical structure 18. Moreover, the first layer 30 may be formed from any one of a variety of materials including but not limited to a shape memory alloy 40. It is understood with respect to all embodiments of the present disclosure, the temperature responsive valve may optionally further include a center post 54 affixed to the housing wherein the center post 54 extends into an opening of the cylindrical structure so that the cylindrical structure defines the decreased diameter. See FIGS. 3A-3B and FIGS. 4-5.

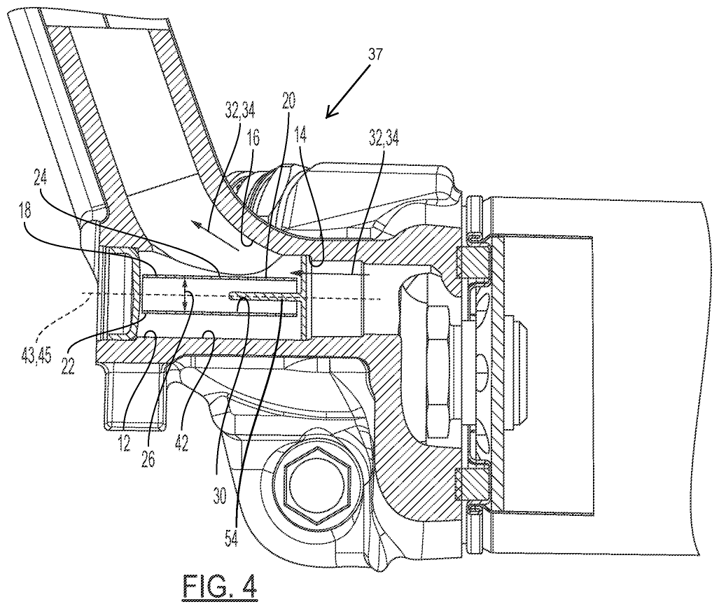

However, with reference to the additional, non-limiting example in FIGS. 4-5, an example embodiment is shown wherein the cylindrical structure 18 is disposed in an oil filter adapter 37 such that the cylindrical structure 18 restricts the fluid pathway 34 (FIG. 5) which is defined between the inlet passageway 14 and the outlet passageway 16. Similar to the non-limiting example of FIGS. 2A-3B, the cylindrical structure 18 in FIGS. 4-5 includes a first layer 30 so that the cylindrical structure 18 is configured to expand from a decreased diameter 26 to an increased diameter 28 when the first layer 30 of the cylindrical structure 18 is exposed to a fluid 32 having an increased pre-determined temperature range causing the cylindrical structure 18 restricts fluid pathway 34 between the inlet passageway 14 and the outlet passageway 16 at such increased pre-determined temperature range. It is understood that the first layer 30 may, but not necessarily, be rolled to form the cylindrical structure 18. However, the first layer 30 may simply be configured as a cylinder as shown in FIGS. 4-5. Moreover, the first layer 30 may be formed from any one of a variety of materials including but not limited to a shape memory alloy 40.

Similar to the example of FIGS. 2A-2B, the cylindrical structure 18 of FIGS. 3A-5 may optionally include a second layer 36 affixed to the first layer 30 wherein the second layer 36 spans across a first side 38 of the first layer 30. Regardless of whether the cylindrical structure 18 is formed by a single layer first layer 30 (as shown in FIGS. 4-5) or by two layers (formed by the first layer 30 and the second layer 36 shown in FIGS. 2A-3B), the layer(s) are rolled to form the cylindrical structure 18.

As shown in FIGS. 2A-5, the housing 12 of temperature responsive valve 10 may further define a bore 42 having an interior housing 12 diameter wherein the bore 42 is fluidly coupled to both the inlet passageway 14 and the outlet passageway 16 of the housing 12. The bore 42 is configured to retain the cylindrical structure 18 within the housing 12 such that the cylindrical structure 18 is maintained or disposed within within the bore 42 regardless of whether or not the cylindrical structure 18 is expanded to the increased diameter 28 (See FIGS. 2B, 3B, 5) or the cylindrical structure 18 has the decreased diameter 26 (See FIGS. 2A, 3A, 4).

With specific reference to the example in FIGS. 3A-3B, the housing defines a shallow bore 42 or cylindrical recess on at least one of the first and second portions 46, 48 to retain the cylindrical structure 18 regardless of whether the cylindrical structure 18 defines a decreased diameter 26 (FIG. 3A) or an increased diameter 28 (FIG. 38). Thus, the bore 42 diameter is greater than each of the decreased diameter 26 and the increased diameter 28 of the cylindrical structure 18 as shown in FIGS. 3A-3B. In the example of FIGS. 3A-3B, the bore 42(s) on at least one of the first and second portions 46, 48 are defined in a middle region 47 of the cavity 50 (between the inlet passageway 14 and the outlet passageway 16). In the example of FIGS. 3A-3B, the cylindrical structure 18 expands to block the fluid pathway 34 between inlet passageway 14 and the outlet passageway 16.

With reference to FIGS. 2A-2B, bore diameter 41 of the bore 42 defined in the housing 12 is also greater than each of the decreased diameter 26 (see FIG. 2A) and the increased diameter 28 (see FIG. 2B) of the cylindrical structure 18. Moreover, as shown in FIGS. 2A-2B, the inlet passageway 14 and the outlet passageway 16 are blocked by the expanded cylindrical structure 18 proximate to the inlet and outlet passageway 16 when the cylindrical structure 18 is exposed to a fluid 32 having a pre-determined increased temperature—which may, but not necessarily, be 40 degrees Celsius.

However, with reference to the examples shown in FIGS. 2A, 3A and 4, when the cylindrical structure 18 defines a decreased diameter 26 (FIGS. 2A, 3A, and 4), the cylindrical structure 18 may optionally be configured to freely move within the bore 42 when the housing 12 and the cylindrical structure 18 is exposed to a fluid 32 having a cooler temperature which is less than the pre-determined temperature such as but not limited to 40 degrees Celsius. However, as noted above, once the cylindrical structure 18 is exposed to fluid 32 having an increased temperature which is greater than the pre-determined temperature, the cylindrical structure 18 fully expands within the bore 42 (FIGS. 2B, 3B, and 5) thereby blocking fluid pathway 34 from the inlet passageway 14 to the outlet passageway 16.

Therefore, as indicated, in the various embodiments of the present disclosure, the first layer 30 of the temperature responsive valve 10 may be rolled to form the cylindrical structure 18. However, where a second layer 36 is optionally affixed across the first layer 30, the second layer 36 is rolled together with the first layer 30 to form the cylindrical structure 18. Regardless, the cylindrical structure 18 is configured to expand (wherein the layer(s) partially unroll as the temperature responsive layer expands). Thus, the cylindrical structure's 18 decreased diameter 26 grows to an increased diameter 28.

With reference to FIGS. 3A-3B, in order to assemble the temperature responsive valve 10, the housing 12 of the temperature responsive valve 10 may optionally be formed by a first portion 46 (or half) which is mechanically affixed to a second portion 48 (or half) after the cylindrical structure 18 is disposed within a portion of the first half of the housing 12. Thus, in the example of FIG. 3A, the cylindrical structure 18 having a decreased diameter 26 may be disposed within the bore 42 during the assembly process. As shown, at least one of the first and second portions of the housing 12 may define a bore 42 which is configured to retain the cylindrical structure 18 within the housing 12 between the inlet passageway 14 and the outlet passageway 16. The temperature responsive valve 10 may be implemented on any one of a variety of components, such as but not limited to an oil cooler.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A temperature responsive valve comprising:
a housing having an inlet passageway and an outlet passageway; and
a cylindrical structure formed by a first layer, and the cylindrical structure having a proximate end, a distal end and a cylinder body;
wherein the cylindrical structure is disposed between the inlet passageway and the outlet passageway so that the cylindrical structure is configured to expand from a decreased diameter to an increased diameter when the first layer of the cylindrical structure is exposed to a fluid having an increased pre-determined temperature so that the cylindrical structure restricts a fluid pathway the inlet passageway and the outlet passageway.

2. The temperature responsive valve as defined in claim 1 further comprising a second layer affixed to the first layer wherein the second layer spans across a first side of the first layer.

3. The temperature responsive valve as defined in claim 1 wherein the first layer is formed from a shape memory alloy.

4. The temperature responsive valve as defined in claim 3 wherein the housing defines a bore having a bore diameter.

5. The temperature responsive valve as defined in claim 4 wherein the cylindrical structure is disposed within the bore.

6. The temperature responsive valve as defined in claim 5 wherein the bore diameter is greater than each of the decreased diameter and the increased diameter of the cylindrical structure.

7. The temperature responsive valve as defined in claim 6 wherein the cylindrical structure is configured to freely move within the bore when the cylindrical structure is exposed to a fluid having a cooler temperature which is less than the pre-determined temperature.

8. The temperature responsive valve as defined in claim 7 wherein the cylindrical structure fully expands within the bore when the cylindrical structure is exposed to a fluid having an increased temperature which is greater than the pre-determined temperature.

9. The temperature responsive valve as defined in claim 8 wherein the first layer is rolled to form the cylindrical structure.

10. The temperature responsive valve as defined in claim 2 wherein the first layer and the second layer are rolled to form the cylindrical structure.

11. The temperature responsive valve as defined in claim 10 wherein the housing is formed by a first portion which is mechanically affixed to a second portion with the cylindrical structure disposed between the first portion and the second portion.

12. The temperature responsive valve as defined in claim 11 wherein the first portion and the second portion define a bore configured to retain the cylindrical structure between the inlet passageway and the outlet passageway.

13. The temperature responsive valve as defined in claim 12 wherein the housing is mounted to an oil cooler.

14. The temperature responsive valve as defined in claim 1 further comprising a center post affixed to the housing wherein the center post extends into an opening of the cylindrical structure so that the cylindrical structure defines the decreased diameter.
